(19) United States
(12) Patent Application Publication
(10) Pub. No.: US 2019/0050384 A1
(43) Pub. Date: Feb. 14, 2019

(54) TECHNIQUES FOR DYNAMICALLY DEFINING A DATA RECORD FORMAT

(71) Applicant: Ab Initio Technology LLC, Lexington, MA (US)

(72) Inventor: Robert Freundlich, Sudbury, MA (US)

(73) Assignee: Ab Initio Technology LLC, Lexington, MA (US)

(21) Appl. No.: 15/837,518

(22) Filed: Dec. 11, 2017

Related U.S. Application Data
(60) Provisional application No. 62/542,631, filed on Aug. 8, 2017.

(51) Int. Cl. G06F 17/27; G06F 3/0484; G06F 3/0482; G06F 17/30

(52) U.S. Cl. CPC G06F 17/271; G06F 17/3056; G06F 3/0482; G06F 3/04842

(57) ABSTRACT

According to some aspects, a tool is provided that reduces errors made by a data processing system by assisting a user in determining a record format for a dataset by dynamically analyzing contents of the dataset based on real-time feedback provided by the user. The data processing system may apply the determined record format to automatically parse contents of the dataset, with fewer errors. According to some aspects, the tool may generate a user interface that allows a user to identify delimiters based on the content of the dataset, and may generate a provisional record format according to the identified delimiters.

### CROSS-REFERENCE TO RELATED APPLICATIONS

The present application claims the benefit under 35 U.S.C. § 119(e) of U.S. Provisional Patent Application No. 62/542,631, filed Aug. 8, 2017, titled “Techniques for Dynamically Defining a Data Record Format,” which is hereby incorporated by reference in its entirety.

### BACKGROUND

An executable program may be configured to read data from one or more datasets during its execution. For example, the datasets may include data stored on a medium that is retrieved by one or more processes of an executable program. Those processes may modify and write the data to one or more output data storage locations. In some cases, it may be desirable to interpret data from a dataset as being associated with particular data fields (also referred to simply as “fields”). The process of interpreting data and determining values of data fields for one or more data records is generally referred to as “parsing” the data. A particular parsing scheme may be defined by the executable program, by the data itself, or by a combination of the program and the data. A parsing scheme, which typically defines how to interpret data for a number of data fields for a number of data records, is sometimes referred to as a “record format.”

In some cases, a data record could be parsed by assuming that data fields in the record are of fixed length. For instance, a date value can always be expressed by eight digits and therefore a “date” data field could be identified by selecting eight characters. In other cases, a data field could have a variable length, and the data can be configured so that a computer process can identify when the field starts and ends by looking at the data.

Data can be configured for variable length fields either via delimiters or by length-prefixing the data. In the delimiter approach, a data field is bounded at one or both ends by a predetermined byte value (or byte sequence) that allows for identification of the bounds of the data field. This approach requires that the data fields not include the character and/or byte value (or sequence)—which is referred to as the “delimiter”—otherwise the computer process would mistakenly identify a point within the data field as being the beginning or end of the data field. The length-prefix approach provides one or more bytes prior to the data field value that indicates to the computer program the length of the data field that is to be read after the length prefix has ended.

### SUMMARY

According to some aspects, a method is provided of determining a record format for a dataset, the dataset comprising a plurality of bytes, the method comprising, with at least one computing device parsing the dataset using a first record format to determine a sequence of characters represented by the plurality of bytes and determining values of one or more data fields in accordance with the first record format, displaying at least some of the values of the one or more data fields in accordance with the first record format via a user interface, displaying a plurality of the sequence of characters via the user interface as a sequence of user interface elements, wherein each of the plurality of characters is presented as a separate user interface element, receiving user input selecting a user interface element of the sequence of user interface elements, the selected user interface element being associated with a character of the sequence of characters, and generating a second record format based on the received input, wherein the second record format is generated to include a data field delimited by the character associated with the selected user interface element.

According to some aspects, a computer system is provided comprising at least one processor, at least one user interface device, and at least one computer readable medium comprising processor-executable instructions that, when executed, cause the at least one processor to parse a dataset comprising a plurality of bytes using a first record format to determine a sequence of characters represented by the plurality of bytes and determining values of one or more data fields in accordance with the first record format, display, via the at least one user interface device, at least some of the values of the one or more data fields of the first record format via the at least one user interface, display, via the at least one user interface device, a plurality of the sequence of characters via the at least one user interface as a sequence of user interface elements, wherein each of the plurality of characters is presented as a separate user interface element, receive, via the at least one user interface device, user input selecting a user interface element of the sequence of user interface elements, the selected user interface element being associated with a character of the sequence of characters, and generate a second record format based on the received input, wherein the second record format is generated to include a data field delimited by the character associated with the selected user interface element.

According to some aspects, a computer system is provided comprising at least one processor, means for parsing a dataset comprising a plurality of bytes using a first record format to determine a sequence of characters represented by the plurality of bytes and determining values of one or more data fields in accordance with the first record format, means for displaying at least some of the values of the one or more data fields of the first record format via the at least one user interface, means for displaying a portion of the sequence of characters via the at least one user interface as a sequence of user interface elements, wherein each character of the portion of the sequence of characters is presented in sequence as a separate user interface element, means for receiving user input associated with a first user interface element of the sequence of user interface elements, the first user interface element associated with a first character of the sequence of characters, and means for generating a second record format based on the received input, wherein the second record format is generated to include a data field delimited by the first character.

A method of determining a record format for a dataset, the dataset comprising a plurality of bytes, the method comprising, with at least one computing device iteratively receiving user input and generating record formats based upon the user input, said iterative process continuing until receiving user input indicating a most recently generated record format is to be output, said iterative process comprising repeating steps of parsing the dataset using an initial record format to determine a sequence of characters represented by the plurality of bytes and determining values of one or more data fields in accordance with the initial record format, displaying at least some of the values of the one or more data fields in accordance with the initial record format via a user interface, displaying a plurality of the sequence of characters via the user interface as a sequence of user interface elements, wherein each of the plurality of characters is presented as a separate user interface element, receiving user input selecting a user interface element of the sequence of user interface elements, the selected user interface element being associated with a character of the sequence of characters, and generating a subsequent record format based on the received input, wherein the subsequent record format is generated to include a data field delimited by the character associated with the selected user interface element.

The foregoing is a non-limiting summary of the invention, which is defined by the attached claims.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 illustrates a process in which a system parses a dataset based on a defined record format, according to some embodiments;

FIG. 2 illustrates a process of parsing a dataset using two different record formats, according to some embodiments;

FIGS. 3A-C depict a user interface with which a user may identify delimiters of a record format, according to some embodiments;

FIG. 4 depicts a user interface with which a user may identify delimiters of a record format and view a generated record format, according to some embodiments;

FIG. 5 is a flowchart of a method of generating a record format based on a user's selection of a delimiter via a user interface, according to some embodiments;

FIG. 6 is a flowchart of a method of generating a record format in which heuristics are applied to generate an initial record format, according to some embodiments; and

FIG. 7 illustrates an example of a computing system environment on which aspects of the invention may be implemented.

### DETAILED DESCRIPTION

The inventors have recognized and appreciated that errors made by a data processing system may be efficiently reduced by equipping the data processing system with a tool to assist a user in defining a record format for a dataset. The tool may dynamically analyze contents of the dataset based on real-time feedback provided by the user. The data processing system may apply the defined record format to automatically parse the contents of the dataset, with fewer errors.

The inventors have recognized and appreciated that, in practice, a user tasked with writing a program that parses contents of a dataset does not necessarily know the appropriate record format with which to interpret the contents as intended by the creator of the dataset. Since datasets, whether they include fixed-length and/or variable-length fields, are often prepared to be interpreted as a collection of data fields in a particular manner, a program that parses such a dataset must be written taking into account the intended interpretation before the dataset can be appropriately utilized by the program. Such an interpretation cannot generally be determined simply by looking at the contents.

The inventors have recognized and appreciated that, for datasets containing delimited data fields, the delimiters should be present in the dataset and have developed techniques for generating a user interface that allows a user to identify delimiters based on the content of the dataset. Some conventional interfaces may allow a user to select a delimiter from a pre-defined list of commonly-used delimiter characters (e.g., a comma) and interpret fields from the contents of the dataset as each being delimited by that character. The inventors have recognized, however, that datasets are in practice often constructed to be interpreted using a number of different data field delimiters and/or using unprintable byte values or characters that are not commonly used as delimiters. Without knowing the appropriate record format to parse such a dataset, it can be very difficult for a user to program a data processing system to properly interpret the contents of the dataset. By providing a tool having an interface that allows a user to quickly select a potential delimiter and see the resulting interpretation of the contents of the dataset based on this selection, the user can efficiently generate an appropriate record format.

According to some embodiments, the tool may generate a user interface including a number of user interface elements that each represent a character from a dataset, and that are presented in the order in which they appear in the dataset. A user can provide input to the tool by interacting with each of the user interface elements to convey whether the character represented by the user interface element should be, or should not be, treated as a delimiter of a data field. After each such interaction, the tool may automatically generate a record format that includes a data field defined as being delimited by the identified delimiter. Some or all of the contents of the dataset may be parsed and presented on the user interface in accordance with the record format. The resulting effects of parsing the dataset using this newly generated record may then be examined by visual inspection by a user through the user interface and/or by an automated analysis by the tool. Thus, whether the selected character is, or is not, a delimiter can be quickly determined. Since the characters are displayed in the same order as they appear in the dataset, a user can easily identify which characters are delimiter candidates and, by interacting with the corresponding user interface element of the tool, quickly generate new record formats until the record format used to generate the dataset is determined.

According to some embodiments, the tool's user interface may include a preview of the dataset contents as parsed with the record format defined by the selected delimiters. This preview may be regenerated automatically when any of the displayed delimiters are selected or unselected, or may be regenerated in response to interaction with a user interface element other than the displayed delimiters (e.g., a “refresh” button). In either case, a user selecting or deselecting delimiters from the displayed sequence of characters of the dataset can quickly ascertain the effects upon parsing contents of the dataset and determine whether a character has been inappropriately selected as a delimiter, or whether there is another unselected character that should be selected as a delimiter. Examples of such processes are discussed in further detail below.

As used herein, a “character” of a dataset may be a printable or a non-printable character, and may be represented in the dataset as any number of bits or bytes. For instance, ASCII characters may be represented by a single byte, and include printable characters (e.g., letters, numbers, etc.) as well as non-printable characters (e.g., the byte value of zero). Alternatively, some datasets may be read using character sets that interpret multiple bytes to represent one character. For instance, a UTF-8 character may be represented by one, two, three or four bytes, and could be a printable character or a non-printable character. Datasets may be interpreted using any suitable character set, as the techniques described herein are not so limited. The user interface may represent non-printable characters in any suitable way, including by displaying the byte value of the character (e.g., “\x09” for the tab character) or by displaying a shorthand representation of the character (e.g., “TAB” or “\t” for the tab character).

According to some embodiments, an initial selection state of each of the displayed user elements representing characters of the dataset may be predetermined upon initial generation of the user interface. That is, whether each of the user elements is initially in a selected state, or in an unselected state, may be predetermined. In some embodiments, heuristics may be applied to the dataset to make an initial qualitative estimation of which characters are delimiters, and the corresponding user interface elements of the user interface may be generated to initially be selected, whereas other characters may be generated to initially be unselected. This approach may therefore provide a user with a starting point in selecting the delimiters, which may decrease the time needed for the user to determine the appropriate record format.

Following below are more detailed descriptions of various concepts related to, and embodiments of, techniques for dynamically defining a data record format. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

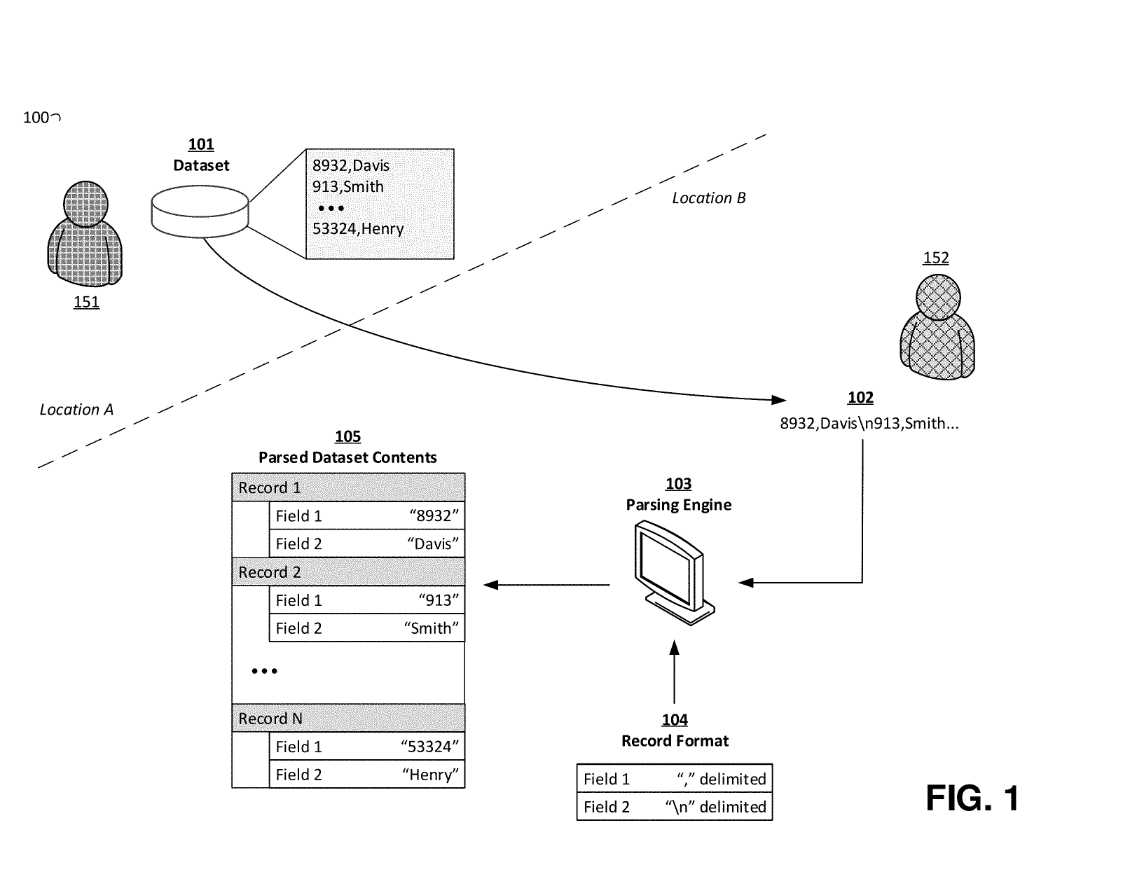

FIG. 1 illustrates a process in which a system parses a dataset based on a defined record format, according to some embodiments. Process 100 is provided as one illustrative example of parsing a dataset using a record format for purposes of explanation. In the example of process 100, a user 151 in a location A creates a dataset 101 that is intended to be parsed using a “canonical” record format. A user 152 in location B receives the data 102, which may not be readily understandable by user 152. The user 152 in the example of FIG. 1 operates a parsing engine executed by system 103, which reads a record format 104 as input and produces data structure 105 in which portions of the dataset are associated with particular records and data field values within those records. While, for clarity of explanation, the record format 104 in the example of FIG. 1 is comparatively simple, it will be appreciated that in general a record format necessary to properly parse a dataset as intended may be far more complex and may contain tens or even hundreds of fields.

In the example of FIG. 1, the dataset 101 has been configured to be interpreted in a particular manner—namely, that each record is separated by a new line and within each record there are two data fields separated by a comma. This manner of interpretation may be defined by a record format, referred to herein as the “canonical” record format. In the example of FIG. 1, the user 152 determines or otherwise has access to the canonical record format 104, which defines “field 1” to be a comma-delimited field and “field 2” to be a newline-delimited field, and thereby appropriately parses the dataset based on this record format. The record format represented in FIG. 1 may in practice be programmatically represented in any suitable way.

When parsing the dataset 101 using the record format 104, a computer-implemented parsing engine may operate in the following manner. Initially, the parsing engine may determine a value of “field 1” in a first record by looking through the characters of the dataset for a “,” character. For instance, the system may read bytes in a sequence from a dataset, such as a flat file or database table, until a byte value of the “,” character is identified. Once this character is found in the dataset (between the “2” and “D” characters), the preceding characters may be identified as the value of “field 1” for the first record, and the parsing engine may then determine a value of “field 2” by looking through the subsequent characters of the dataset for a newline character (sometimes represented by the shorthand “\n”). The system may create a data structure for the records (e.g., in computer memory) and insert the value of each field as it is determined into this data structure. Once the “\n” character is found (between the “s” and “9”), the preceding characters are identified as the value of “field 2” for the first record, and the parsing engine may then attempt to determine a value of “field 1” in a second record. This process may continue until all of the characters in the dataset have been read and the system's record data structure has been filled with data from the dataset.

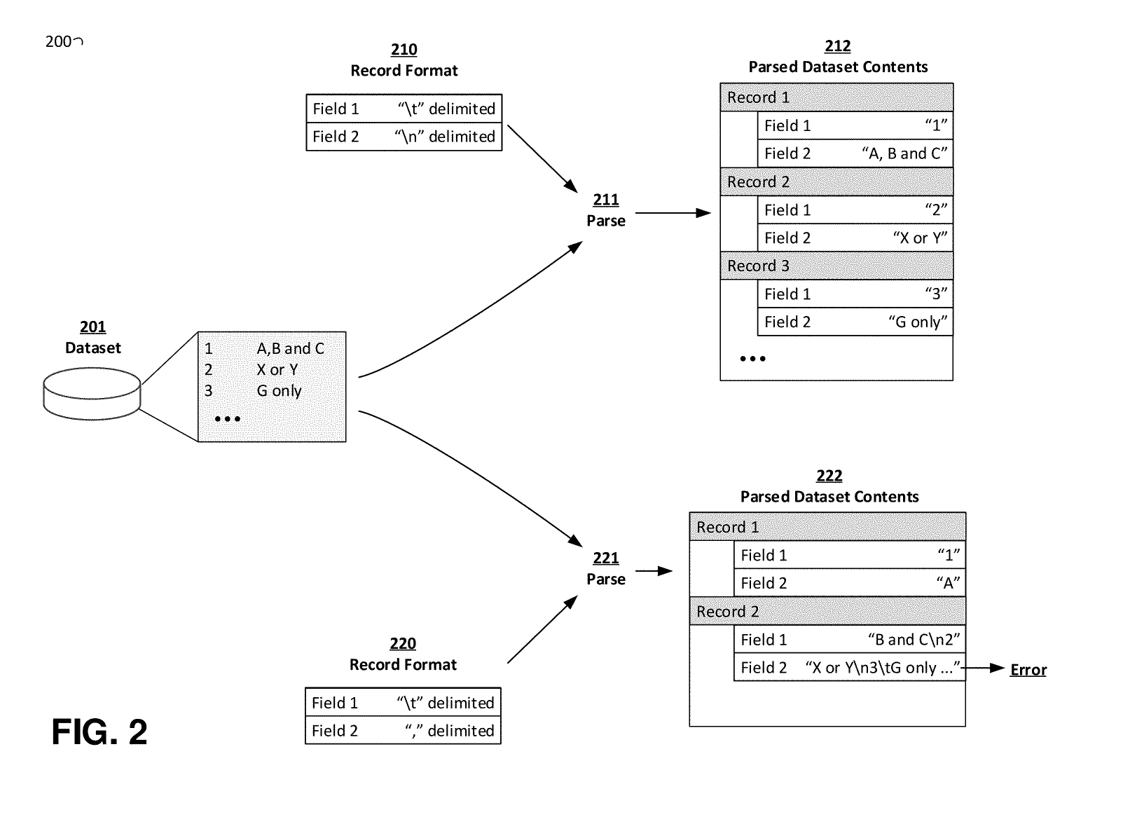

It is important when parsing a dataset using delimiters that there be no missing delimiters in the data, otherwise the parsing engine would either never find the end of a data field or would produce a data field value that would contain values that were intended by the creator of the dataset to instead be placed within other data fields of the record. Similarly, if the record format is inappropriately defined to include a data field delimited by a character that does not appear in the data file, the parsing engine would never find the end of the data field. FIG. 2 illustrates an example of this problem, where a user may not know the canonical record format and tests two different “provisional” record formats to determine which, if any, matches the canonical record format.

In the example of FIG. 2, a dataset 201 is parsed using a record format 210 and also using a record format 220. Record format 210 matches the canonical record format and therefore appropriately describes the format of dataset 201, whereas record format 220 does not. Record format 220 includes a tab-delimited field (where a tab is denoted by the symbol “\t”), but includes a comma delimited field and the dataset 201 does not define the second field by comma delimiters, although the first few characters of the dataset do include a comma. Parsed dataset 222 is therefore produced in the following manner.

First, a system executing a parsing engine determines a value of “field 1” in a first record by looking through the characters of the dataset for a tab character, starting with the first character in the dataset. The first-encountered tab character is located after the “1” and before the “A.” The value of “field 1” is therefore defined to be “1” since this character is the only one between the start of the dataset and the identified delimiter. A value of “field 2” is then determined for the first record by looking through the subsequent characters of the dataset for a comma character, which is located after the “A” and before the “B.” The value of “field 2” is therefore defined to be “A.” In the parsing engine's execution, identification of a value for “field 2” completes a first record and the engine when begins a process of identifying a first field of the second record. The parsing engine determines a value of “field 1” in a second record by looking through the characters of the dataset after the end of the first record (after the comma) for a tab character. This is found after the “2” character and before the “X” character, and as a result the value of “field 1” is therefore defined to be “B and C\n2” where “\n” represents a newline character. Then a value of “field 2” is determined for the second record by looking through the subsequent characters of the dataset for a comma character, but there is no such character. As a result, the parsing engine is unable to determine the bounds of the “field 2” data field of the second record. This may produce an error, either because the data field is identified to have exceeded some predefined maximum field size or because a memory or buffer overflow error occurs. In either case, the dataset is not parsed as intended by the creator of the dataset.

A user faced with the error depicted in FIG. 2 would conventionally examine the data using an editor or other viewing application and try to figure out the underlying cause of the observed error based on a visual inspection. Although FIG. 2 illustrates a comparatively simple example, record formats can sometimes contain dozens or even hundreds of data fields, making such a task very challenging. Even once a potentially inappropriate delimiter has been identified, the user must produce a new provisional record format (e.g., by typing in a new delimiter in the appropriate place) and operate a parsing engine to reparse the dataset using the new record format. Such a process can be imprecise, error prone and time consuming.

It may be noted that, in some cases, a parsing engine may successfully parse a dataset without producing the type of error illustrated in FIG. 2 and described above yet with values assigned to certain fields that are other than intended by the creator of the dataset. For instance, in the example of FIG. 2, a provisional record format with a single field that is newline-delimited would parse the dataset 201 without error, yet the resulting parsed dataset would not contain data in each record that was as intended by the creator of the dataset. In such cases, an error may be subsequently produced during operations upon the data structure containing the parsed dataset.

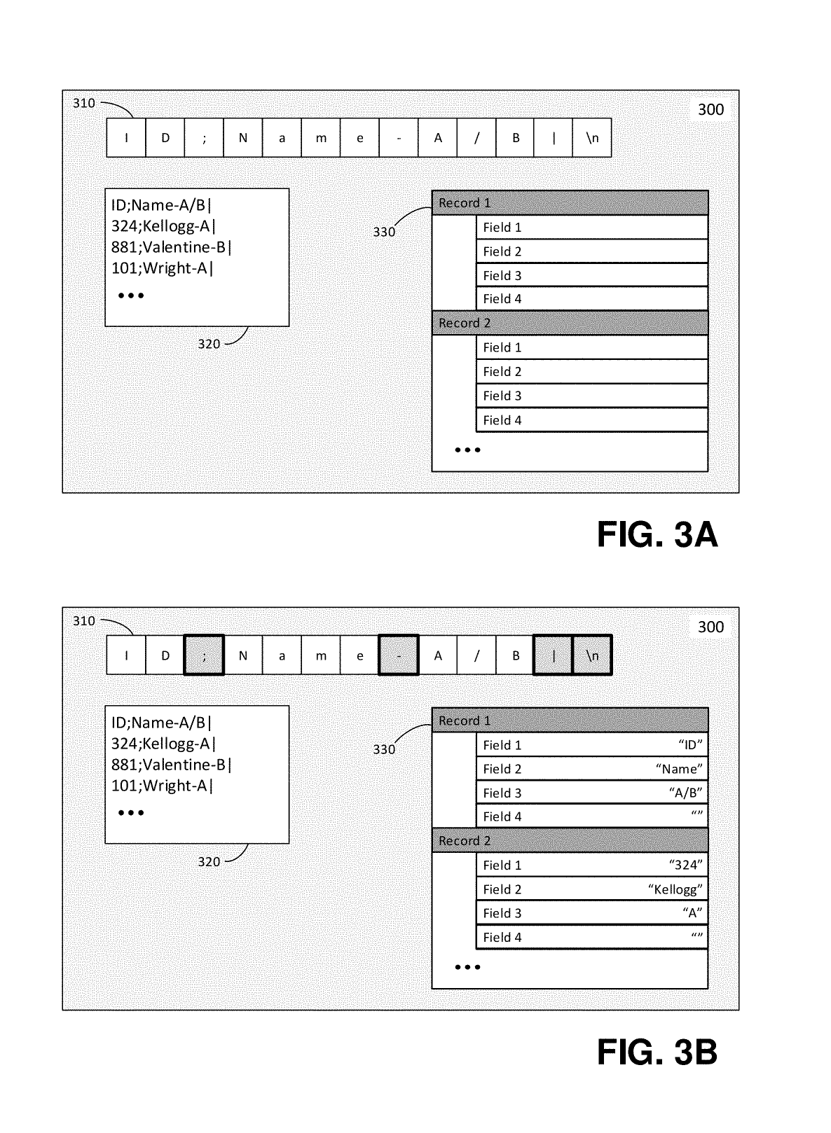

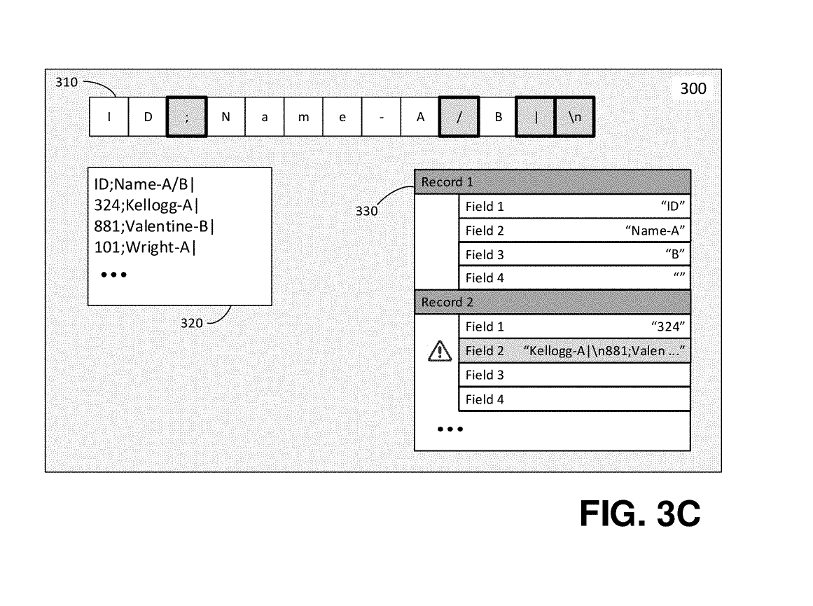

To illustrate how the tool as described herein may operate to determine the canonical record format, FIGS. 3A-C depict a user interface via which a user may identify delimiters of a record format, according to some embodiments. A suitable system may execute the tool as described herein, which in part produces the user interface pictured. Moreover, the tool may execute a parsing engine as described below.

FIG. 3A illustrates an initial state of a user interface 300 that includes user interface elements 310 that depict sequential characters from a dataset. Each pictured square depicting a single character within user interface elements 310 is an independent user interface element that may be in a selected state or in a unselected state. A portion of the dataset is shown in user interface element 320, and a number of records and data fields produced by parsing the dataset using a provisional record format generated according to the delimiters selected from amongst user interface elements 310 are shown as user interface element 330. In the illustrative user interface, characters shown in the user interface elements 310 that are selected as delimiters are highlighted and shaded gray, whereas unselected characters are shaded white. In the illustrated example of FIG. 3A, therefore, which may represent an initial stage in defining a record format, no delimiters are selected.

A user viewing the user interface 300 shown in FIG. 3A can visually inspect the results of parsing the dataset using the identified delimiters (which currently shows no data field values because no delimiters have yet been selected). By looking at the data in user interface element 320, the user can identify potentially appropriate delimiters not selected (e.g., by noticing that the “−” character appears multiple times) and identify potentially inappropriate delimiters (e.g., the “/” character).

According to some embodiments, to change the record format the user may interact with one of the user interface elements 310 (e.g., by clicking on the element with a mouse pointer) to change its state from selected to unselected, or vice versa. The parsing engine executed by the tool may then reparse the dataset and display the results in user interface element 330; this operation may be performed in response to the user's changing of the state of a user interface element 310, or may be performed in response to the user interacting with another user interface element not shown in the figure (e.g., a button that regenerates the contents of user interface 330 by generating a new record format according to the selected delimiters and reparsing the dataset using this record format).

FIG. 3B illustrates a subsequent state of the user interface 300 after a user interacts with the interface shown in FIG. 3A to change the state of the “;”, “−”, “|” and “\n” character user interface element from unselected to selected. In response to these changes in state or due to some other instruction via the user interface, the tool producing the user interface 300 generated a new record format based on the new set of delimiters and parsed the dataset again using the newly generated record format. Results of parsing the dataset with the new record format are shown in the user interface element 330, which has been updated by the tool producing the user interface to reflect the results.

A user now has visual confirmation that the selected group of delimiters appropriately parse the dataset, as user interface element 330 illustrates values for a number of fields that appear to contain consistent data and generate no errors. In some embodiments, the tool may select a subset of the records to display. In some cases, the tool may parse only a portion of the records in order to display this subset. In some embodiments, a subset of records may be selected by interface elements provided by user interface 300 that enable a user to examine a number of records, which may span across the dataset, to ensure that the dataset is fully parsed from start to finish. For instance, the user interface 300 may depict records from the start, middle and/or end of the dataset, and/or may provide a control that a user may operate to scroll through the records produced by parsing of the dataset using the selected delimiters. Parsing a portion of the records (e.g., the first ten records, the first five records and the last five records, etc.) using the generated record format may efficiently allow the user to obtain visual confirmation that the generated record format appropriately parses the dataset without it being necessary to parse the entire dataset. The user may thereby efficiently select the appropriate delimiters, obtain confirmation of appropriate parsing, and record the resulting record format.

As a result of the above-described process, the tool producing user interface 300 enabled a user to select an appropriate set of delimiters from amongst a finite number of choices. A provisional record format was generated according to this set of delimiters, and feedback was provided through the user interface such that the user could establish whether or not the provisional record format matches the canonical record format. Since the choices of delimiter presented are from the dataset itself, the delimiters of the canonical record format must be present within those choices. Moreover, selection or deselection of a delimiter, and generation of a new provisional record format reflecting the new set of delimiters, can be limited to interaction (e.g., a mouse click) with a single user interface element. Finally, by providing prompt feedback of the results of parsing the dataset with the newly generated provisional record format, the user can obtain direct feedback on the effects the change in delimiter had upon how the data is parsed. Together, these advantages produce a process in which a (potentially complex) record format may be determined quickly and accurately.

FIG. 3C illustrates an alternative selection of delimiters from FIG. 3B. FIG. 3C may represent a subsequent state to FIG. 3A in which the selected delimiter characters in FIG. 3C were been selected by a user faced with the user interface of FIG. 3A. Alternatively, FIG. 3C may be an initial stage in defining a record format where the selected delimiters were automatically selected by the system producing user interface 300. As discussed above, heuristics may be applied to a dataset to make an initial guess as to the correct delimiters, thereby providing a user with a starting point in selecting delimiters. The selected delimiters in FIG. 3C may have been selected via such heuristics, examples of which are described below.

In the example of FIG. 3C, the “/” character has been selected as a delimiter for the dataset, yet while this character appears amongst the first few characters of the dataset, the character is not used by the dataset as a delimiter throughout. Moreover, the “−” character, which is used in the dataset to separate a name from a subsequent value of “A,” “B” or “A/B” has not been selected as a delimiter. As a result, while the first three fields of the first record shown in user interface element 330 appropriately identify the value of “Field 1” as “ID,” the subsequent fields contain information other than intended by the creator of the dataset.

In the example of FIG. 3A, the illustrative inappropriate set of delimiters selected produces an error (indicated by a triangular warning symbol) due to the determined value of “field 2” of the second record overrunning a maximum field size. This provides additional feedback to the user indicating that the currently-selected set of delimiters are not an appropriate set with which to fully parse the dataset. In other cases, a different set of delimiters may not produce an error as shown because the data is parsed successfully, yet the user can visually inspect the user interface element 330 and identify that the record format is other than intended by examining the values of the parsed fields of the dataset shown.

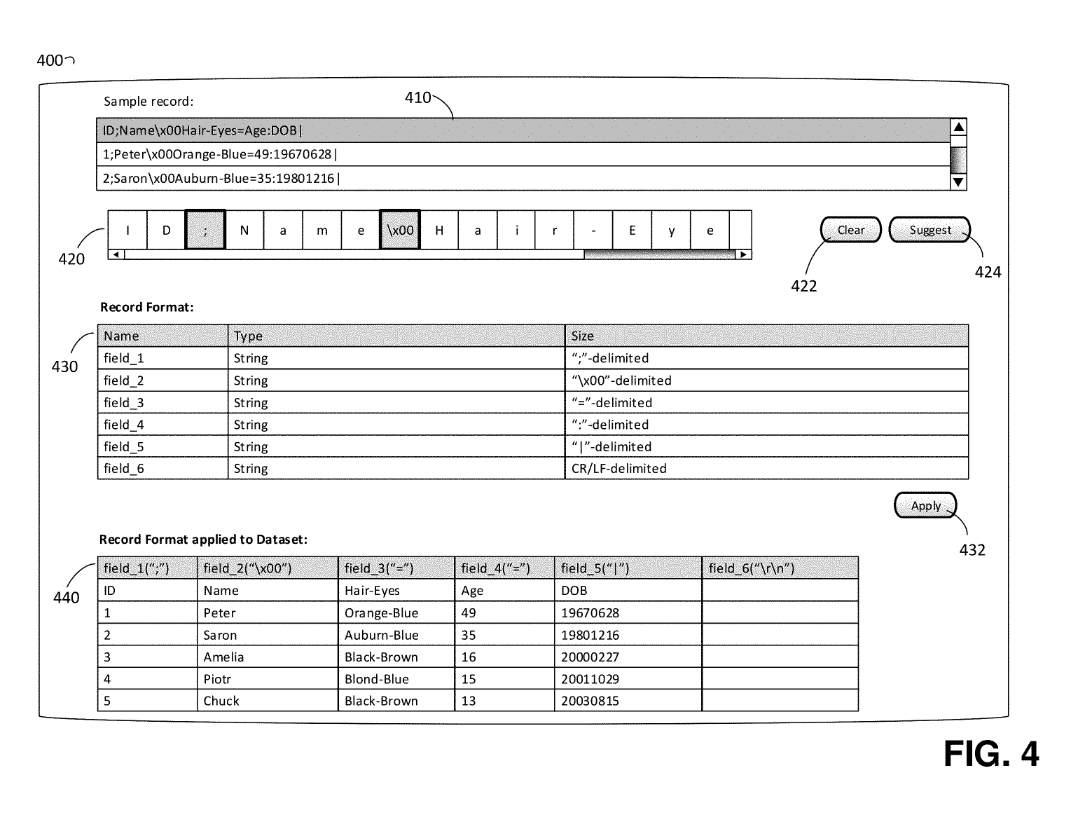

FIG. 4 depicts a user interface via which a user may identify delimiters of a record format and view a generated record format, according to some embodiments. User interface 400 shares some features of the user interface 300 shown in FIGS. 3A-3C but provides additional controls and presents the information shown in user interface 300 in a different manner. As with the example of FIG. 3, a suitable system may execute the tool as described herein, which in part produces the user interface shown in FIG. 4. Moreover, the tool may execute a parsing engine in conjunction with the user interface as described below.

In the example of FIG. 4, user interface 400 includes user interface elements 420 that depict sequential characters from a dataset. Each pictured square of user interface elements 420 depicting a single character is an independent user interface element. A portion of a dataset is shown in user interface element 410, and a number of records and data fields produced by parsing the dataset according to the delimiters selected from amongst user interface elements 420 are shown as user interface element 440. User interface elements from amongst the user interface elements 420 that are selected as delimiters are highlighted and shaded gray in FIG. 4, and unselected characters are shaded white. In addition, user interface element 430 depicts a provisional record format generated by the system based on the selected delimiters amongst user interface elements 420. The most recently generated record format depicted by user interface element 430 is the record format used to parse the dataset and produce the records shown in user interface element 440.

In the example of FIG. 4, user interface elements 420 are contained within a user interface element having a scroll bar, so that while some characters of the dataset are displayed in the user interface 400, there are additional characters available for display and selection as delimiters by operating the scroll bar. In some embodiments, moving the scroll bar may trigger loading of additional characters from the dataset. For example, the system may initially retrieve the first N characters of the dataset and produce N user interface elements for these characters, but when the scroll bar is moved to the right, the system may retrieve additional characters subsequent to the N characters in the dataset and produce additional corresponding user interface elements. This process of retrieving additional characters may be repeated each time the scroll bar is moved to the end. In this manner, any number of characters of the dataset may be viewed by the user in selecting delimiters, though to minimize unnecessary computational operations, the characters may be retrieved as needed as informed by user actions, rather than in advance.

In the example of FIG. 4, user interface element 410 depicts a number of records from the dataset, where a particular end-of-record delimiter has been assumed to break up the dataset into records. In some embodiments, the end-of-record delimiter may be assumed to be a newline character (ASCII byte value 0×0A), or a combination of a carriage return character and a newline (also called line feed) character (ASCII byte value 0×0D0A). In other embodiments, an end-of-record delimiter may be assumed to be the last delimiter currently selected amongst user interface elements 420.

In the example of FIG. 4, records shown in user interface element 410 (which may themselves be represented by individual user interface elements) may be selected and user interface element 420 generated to display characters from the selected record for selection as delimiters. Prior selection of delimiters may be maintained when the selected record in element 410 changes—that is, the group of selected delimiters in the user interface element 420 may be initially set to the same characters as were selected in user interface element 420 before the selected record was changed. This allows a user to visually inspect the selected delimiters in another record.

In operation, the tool executing the illustrated user interface 400 generates a new provisional record format according to the selection of delimiters identified through user interface element 420 (e.g., generates a new record format whenever the set of selected delimiters changes). When the “Apply” button 432 is activated or otherwise, the dataset may be parsed using the new provisional record format by a parsing engine executed by the tool, and results of said parsing are shown by user interface element 440. Parsing of the dataset by the tool using the most recently generated record format may be performed in response to a change in the selected/unselected state of any of the characters shown by user interface elements 420, and/or in response to activation of the “Apply” button 432.

The illustrative user interface 400 includes a “Clear” button 422 which, when activated, deselects all of the characters as delimiters. The interface 400 also includes a “Suggest” button 424 which, when activated, applies heuristics to determine a set of delimiters that may match the data. These heuristics may sometimes produce the appropriate set of characters, and sometimes may not, but they can be used to at least provide a starting point for a user trying to determine the set of delimiters. Examples of such heuristics are described below.

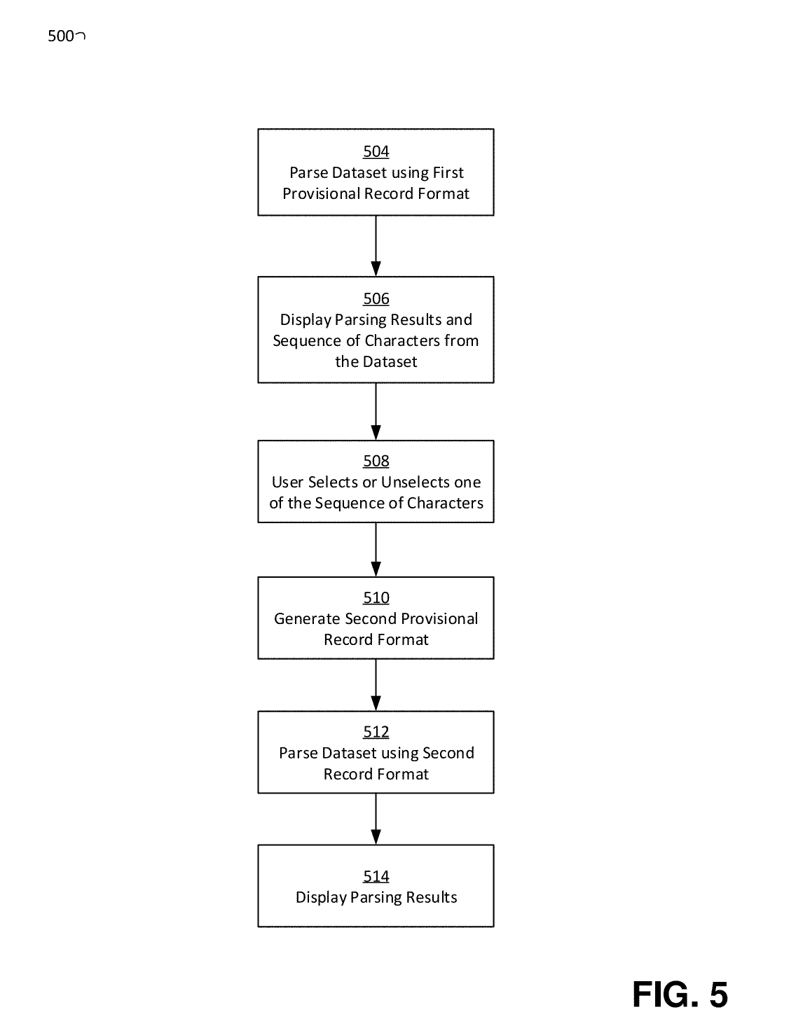

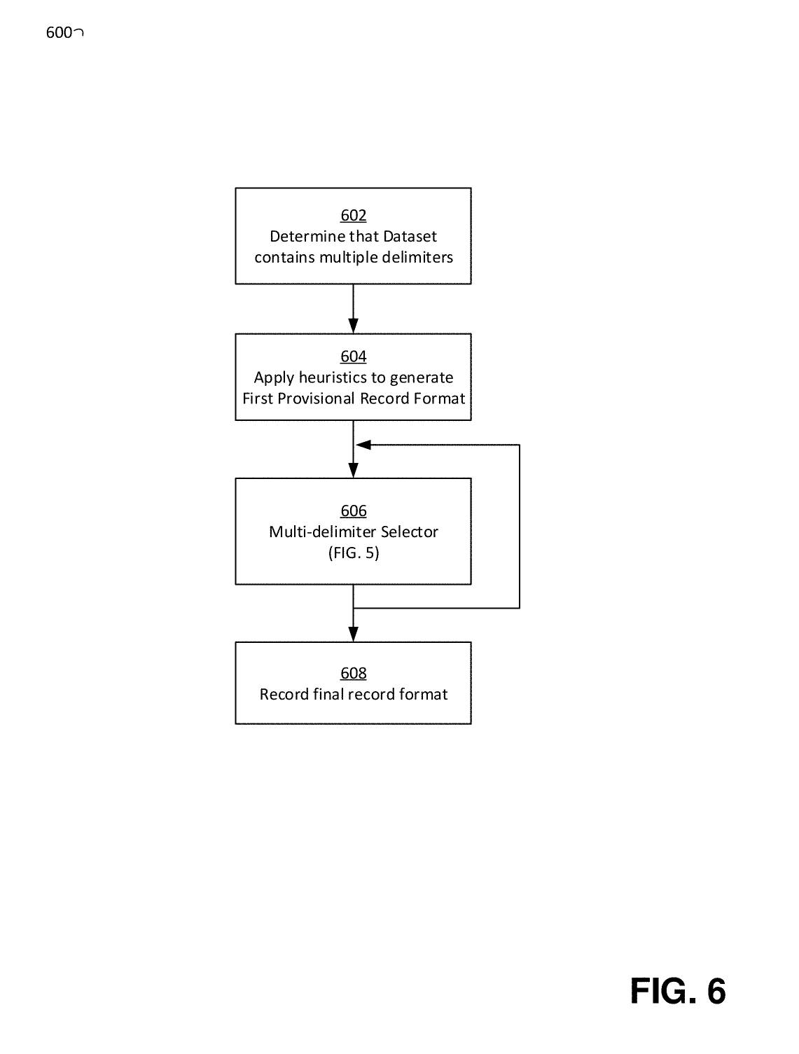

FIG. 5 is a flowchart of a method of determining a provisional record format based on a user's selection of a delimiter via a user interface, according to some embodiments. Method 500 may be performed by a system executing a tool as described herein generating a user interface, including but not limited to user interfaces 300 and 400 shown in FIGS. 3A-C and FIG. 4, respectively. As discussed above, while a dataset may be created with a canonical record format by one user (e.g., user 151 in FIG. 1), a different user accessing the data (e.g., user 152 in FIG. 1) may not know this record format, and may, using the tool described herein, generate a number of provisional record formats before determining the canonical record format. Method 500 illustrates a portion of this process in which a first provisional record format has been generated, a delimiter character is selected or unselected, and a second provisional record format is generated.

Method 500 begins in act 504 in which a dataset is parsed by a parsing engine executed by the tool according to a first provisional record format. The dataset may be located on any number of non-transitory computer-readable medium accessible to the system executing method 500, or may be provided as a data stream being received from an external system. In some cases, the dataset may be a file stored by one or more volatile and/or non-volatile computer readable storage media. In some cases, the dataset may be data stored within a database (e.g., the dataset may be a table or view of a database). Irrespective of how or where the dataset is stored, the system executing method 500 executes in act 504 a parsing engine to produce a data structure containing records and data fields by parsing the dataset according to the first provisional record format. The first provisional record format may, in some cases, be an empty or otherwise undefined record format when no delimiters have as yet been selected. In other cases, the first provisional record format may include a single delimited field to separate records from one another (e.g., “\n” delimiter) but may otherwise not identify separate fields within each record.

In act 506, results of parsing the dataset are displayed via a user interface along with a sequence of characters from the dataset. Displaying results of parsing the dataset may include displaying of some or all of the records and/or data fields produced in act 504, and may include displaying additional results, such as error messages or other feedback messages relating to parsing of the dataset, via the user interface. The sequence of characters displayed in act 506 may be displayed in the user interface in an order matching that order in which the characters appear in the dataset.

In some embodiments, a selected or unselected state in the user interface of each character of the sequences of characters displayed in act 506 may be determined according to the first provisional record format. That is, the delimited fields defined by the first provisional record format may imply which of the characters of the dataset being shown in the user interface have been selected as delimiters, and these characters may be displayed in the user interface in act 506 as being in a selected state. A selected state in the user interface may include any visual approach or approaches to visually distinguish the selected characters from the unselected characters.

In act 508, a user may provide input to the user interface that causes one of the sequence of characters to change from an unselected state to a selected state, or from a selected state to an unselected state. This input may be provided using any suitable input device and in any suitable way (e.g., by clicking on a user interface element with a mouse or other input device). In act 510, a second provisional record format is generated by the system based on the set of selected delimiters amongst the displayed sequence of characters (which includes the change in said set that occurred in act 508). This set of selected delimiters will either include a character selected in act 508 or will not include a character that was unselected in act 508. Accordingly, in cases where the second provisional record format is generated without additional selection or deselection of characters, the second provisional record format may differ from the first provisional record format by either including an additional data field delimited by the character selected in act 508 or by not including a data field delimited by the character that was deselected in act 508. Aside from this field the two record formats may be otherwise identical.

In act 512, the dataset is parsed by a parsing engine executed by the tool according to the second provisional record format. The system executing method 500 executes the parsing engine to produce a data structure containing records and data fields by parsing the dataset according to the second record format. In act 514, results of parsing the contents of the dataset in act 512 are displayed via the user interface. Displaying results of parsing the dataset may include displaying of some or all of the records and/or data fields produced in act 512, and may include displaying additional results, such as error messages or other feedback messages relating to parsing of the dataset, via the user interface.

It will be appreciate that method 500 may be repeated any number of times until a user accepts the most recently generated record format. In some embodiments, the user interface may accordingly include one or more controls that, when activated, proceed to a next step in a process that comprises method 500. Such next steps may include recording the accepted record format in a metadata repository or other datastore (e.g., a database) and/or executing a dataflow graph wherein a dataset is parsed using the accepted record format.

FIG. 6 is a flowchart of a method of generating a record format in which heuristics are applied to generate an initial record format, according to some embodiments. Method 600 may be executed by a tool as described herein. In some embodiments, the method 600 may be executed by a system that generates a record format for a dataset by prompting for input from a user that is not limited only to delimited datasets. In some cases, the system may perform an analysis of the dataset to determine what types of data fields might be present and which type of process would best suit generation of an appropriate record format. For example, a dataset that repeatedly contains a fixed number of characters separated by a newline character might be assumed to contain only fixed length fields and a process launched to generate a record format based on user input through a user interface. Alternatively, a dataset that contains a number of instances of potential delimiter characters might be identified as a dataset having multiple delimited fields and therefore the record format may be generated via the techniques described herein.

Method 600 begins in act 602 in which it is determined that a dataset for which a record format is to be generated contains multiple delimiters, and that therefore the record format may be generated via the techniques described herein. Potential delimiters may be identified from a list of characters that are assumed to be delimiters when they appear in data. As a non-limiting example, potential delimiters may include all characters that are not alphanumeric, a space, a quote, a period, a slash (e.g., “/” or “\”) or a hyphen character. This list of potential delimiters would thus exclude most typical data characters and search for repeated instances of characters that would typically not be found in, for example, business data. Note that such an approach would consider non-printable characters like a newline character a potential delimiter.

In act 602, a first record format is generated by apply heuristics to the dataset. According to some embodiments, the first record format may be generated comprising delimited data fields each delimited by one of the potential delimiters identified in act 602. According to some embodiments, a frequency with which potential delimiters appear in the data file may be analyzed to selected delimiters of the record format. For instance, a potential delimiter that appears significantly more than other potential delimiters in the dataset may have been erroneously identified as a delimiter. According to some embodiments, it may be assumed that records end with a newline character (or a carriage return and a newline). According to some embodiments, a parsing engine may determine whether a candidate record format fully parses the dataset (i.e., parses the dataset into a complete number of records) to determine whether a set of delimiters may be the appropriate set for parsing of the dataset. If the record format does not fully parse the dataset, this indicates the set of delimiters is not the appropriate one.

Irrespective of how the first record format is generated in act 604, in act 606 method 500 is executed and a new record format generated according to selection and/or deselection of characters as delimiters. Act 606 may be repeated any number of times until the user is satisfied with the current set of delimiters, at which point the final record format may be recorded in act 608.

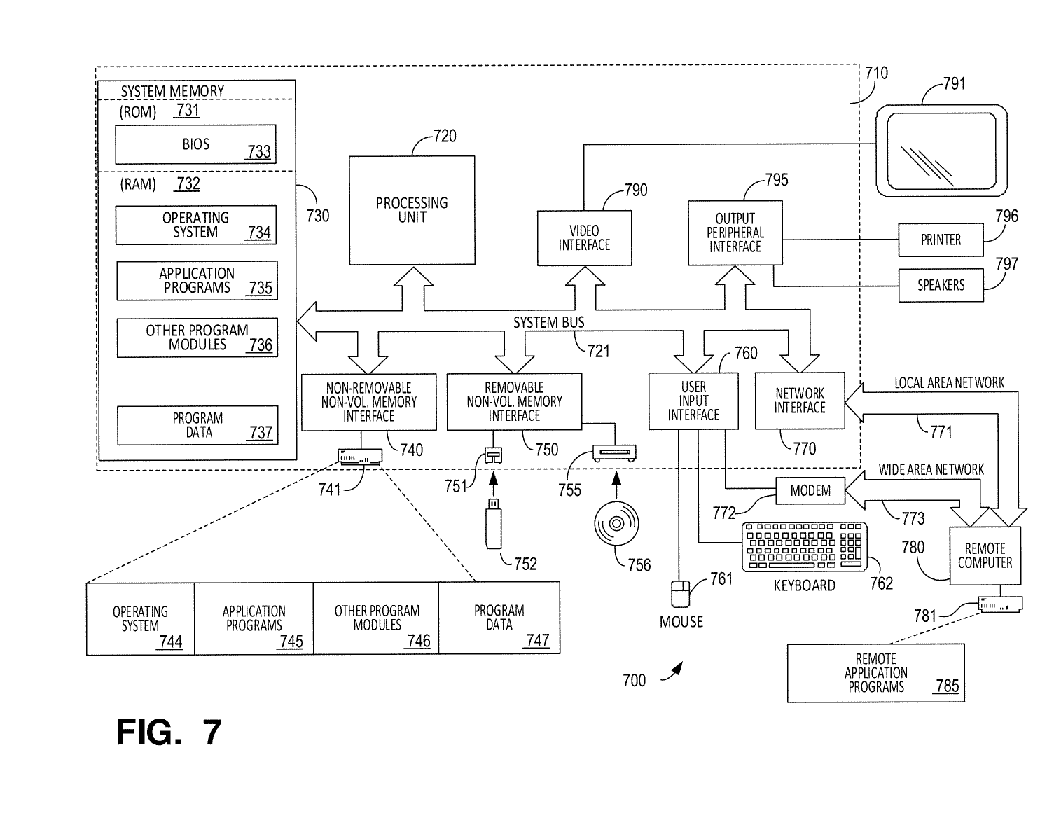

FIG. 7 illustrates an example of a suitable computing system environment 700 on which the technology described herein may be implemented. The computing system environment 700 is only one example of a suitable computing environment and is not intended to suggest any limitation as to the scope of use or functionality of the technology described herein. Neither should the computing environment 700 be interpreted as having any dependency or requirement relating to any one or combination of components illustrated in the exemplary operating environment 700.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 7, an exemplary system for implementing the technology described herein includes a general purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7, provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer 710 through input devices such as a keyboard 762 and pointing device 761, commonly referred to as a mouse, trackball or touch pad. Other input devices (not shown) may include a microphone, joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 795.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

According to some aspects, a method is provided of determining a record format for a dataset, the dataset comprising a plurality of bytes, the method comprising, with at least one computing device parsing the dataset using a first record format to determine a sequence of characters represented by the plurality of bytes and determining values of one or more data fields using the sequence of characters in accordance with the first record format, displaying at least some of the values of the one or more data fields in accordance with the first record format via a user interface, displaying a plurality of the sequence of characters via the user interface as a sequence of user interface elements, wherein each of the plurality of characters is presented as a separate user interface element, receiving user input selecting a user interface element of the sequence of user interface elements, the selected user interface element being associated with a character of the sequence of characters, and generating a second record format based on the received input, wherein the second record format is generated to include a data field delimited by the character associated with the selected user interface element, parsing a portion of the dataset using the second record format, displaying results of said parsing of the portion of the dataset using the second record format via the user interface, receiving user input indicating that the second record format is to be recorded, and recording the second record format on at least one computer readable medium.

According to some embodiments, displaying the plurality of the sequence of characters may comprise displaying a contiguous subset of the sequence of characters via the user interface as the sequence of user interface elements, wherein each character of the subset is presented in sequence as a separate user interface element.

According to some embodiments, the method may further comprise determining that the second record format does not fully parse the dataset by identifying a memory overflow or by identifying a parsed record that comprises one or more unpopulated data fields, and wherein displaying the results of the parsing of the dataset using the second record format via the user interface comprises displaying an alert that the second record format does not fully parse the dataset.

According to some embodiments, the method may further comprise determining the first record format based at least in part on one or more heuristics to identify one or more characters as a potential delimiter.

According to some embodiments, determining the first record format may comprise identifying a character of the dataset that is not alphanumeric, a space, a quote, a period, a forward-slash or a hyphen, and generating a data field of the first record format that is delimited by the identified character.

According to some embodiments, the first character may be a non-printable character.

According to some embodiments, the first record format may include only delimited data fields.

According to some embodiments, the user input may cause the at least one computing device to alter the selected user interface element's appearance in the user interface.

According to some embodiments, displaying the results of said parsing of the dataset using the first record format via the user interface may comprise displaying a list of records of the dataset and data field values of the records.

According to some embodiments, the first record format may include a plurality of delimited data fields having a plurality of different delimiters.

According to some aspects, a computer system is provided comprising at least one processor, at least one user interface device, and at least one computer readable medium comprising processor-executable instructions that, when executed, cause the at least one processor to parse a dataset comprising a plurality of bytes using a first record format to determine a sequence of characters represented by the plurality of bytes and determining values of one or more data fields in accordance with the first record format, display, via the at least one user interface device, at least some of the values of the one or more data fields of the first record format via the at least one user interface, display, via the at least one user interface device, a plurality of the sequence of characters via the at least one user interface as a sequence of user interface elements, wherein each of the plurality of characters is presented as a separate user interface element, receive, via the at least one user interface device, user input selecting a user interface element of the sequence of user interface elements, the selected user interface element being associated with a character of the sequence of characters, generate a second record format based on the received input, wherein the second record format is generated to include a data field delimited by the character associated with the selected user interface element, parsing a portion of the dataset using the second record format displaying results of said parsing of the portion of the dataset using the second record format via the user interface, receiving user input indicating that the second record format is to be recorded, and recording the second record format on at least one computer readable medium.

According to some embodiments, displaying the plurality of the sequence of characters may comprise displaying a contiguous subset of the sequence of characters via the user interface as the sequence of user interface elements, wherein each character of the subset is presented in sequence as a separate user interface element.

According to some embodiments, the processor-executable instructions may further cause the at least one processor to determine that the second record format does not fully parse the dataset by identifying a memory overflow or by identifying a parsed record that comprises one or more unpopulated data fields, and wherein displaying the results of the parsing of the dataset using the second record format via the user interface comprises displaying an alert that the second record format does not fully parse the dataset.

According to some embodiments, the processor-executable instructions may further cause the at least one processor to determine the first record format based at least in part on one or more heuristics to identify one or more characters as a potential delimiter.

According to some embodiments, determining the first record format may comprise identifying a character of the dataset that is not alphanumeric, a space, a quote, a period, a forward-slash or a hyphen, and generating a data field of the first record format that is delimited by the identified character.

According to some embodiments, determining the first record format may comprise identifying a data record delimiter.

According to some embodiments, the user input may cause the at least one processor to alter the first user interface element's appearance in the user interface.

According to some embodiments, displaying the results of said parsing of the dataset using the first record format via the at least one user interface device may comprise displaying a list of records of the dataset and data field values of the records.

According to some embodiments, the first record format may include a plurality of delimited data fields having a plurality of different delimiters.

According to some aspects, a computer system is provided comprising at least one processor, means for parsing a dataset comprising a plurality of bytes using a first record format to determine a sequence of characters represented by the plurality of bytes and determining values of one or more data fields in accordance with the first record format, means for displaying at least some of the values of the one or more data fields of the first record format via the at least one user interface, means for displaying a portion of the sequence of characters via the at least one user interface as a sequence of user interface elements, wherein each character of the portion of the sequence of characters is presented in sequence as a separate user interface element, means for receiving user input associated with a first user interface element of the sequence of user interface elements, the first user interface element associated with a first character of the sequence of characters, means for generating a second record format based on the received input, wherein the second record format is generated to include a data field delimited by the first character, means for parsing a portion of the dataset using the second record format, means for displaying results of said parsing of the portion of the dataset using the second record format via the user interface, means for receiving user input indicating that the second record format is to be recorded, and means for recording the second record format on at least one computer readable medium.

According to some aspects, a method is provided of determining a record format for a dataset, the dataset comprising a plurality of bytes, the method comprising, with at least one computing device iteratively receiving user input and generating record formats based upon the user input, said iterative process continuing until receiving user input indicating a most recently generated record format is to be output, said iterative process comprising repeating steps of parsing the dataset using an initial record format to determine a sequence of characters represented by the plurality of bytes and determining values of one or more data fields in accordance with the initial record format, displaying at least some of the values of the one or more data fields in accordance with the initial record format via a user interface, displaying a plurality of the sequence of characters via the user interface as a sequence of user interface elements, wherein each of the plurality of characters is presented as a separate user interface element, receiving user input selecting a user interface element of the sequence of user interface elements, the selected user interface element being associated with a character of the sequence of characters, generating a subsequent record format based on the received input, wherein the subsequent record format is generated to include a data field delimited by the character associated with the selected user interface element, and ending the iterative process upon receiving the user input indicating a most recently generated record format is to be output, and recording the most recently generated record format on at least one computer readable medium.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a non-transitory computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of determining a record format for a dataset, the dataset comprising a plurality of bytes, the method comprising, with at least one computing device:
parsing the dataset using a first record format to determine a sequence of characters represented by the plurality of bytes and determining values of one or more data fields in accordance with the first record format;
displaying at least some of the values of the one or more data fields in accordance with the first record format via a user interface;
displaying a plurality of the sequence of characters via the user interface as a sequence of user interface elements, wherein each of the plurality of characters is presented as a separate user interface element;
receiving user input selecting a user interface element of the sequence of user interface elements, the selected user interface element being associated with a character of the sequence of characters; and
generating a second record format based on the received input, wherein the second record format is generated to include a data field delimited by the character associated with the selected user interface element.

2. The method of claim 1, wherein displaying the plurality of the sequence of characters comprises:
displaying a contiguous subset of the sequence of characters via the user interface as the sequence of user interface elements, wherein each character of the subset is presented in sequence as a separate user interface element.

3. The method of claim 1, further comprising:
parsing the dataset using the second record format; and
displaying results of said parsing of the dataset using the second record format via the user interface.

4. The method of claim 3, further comprising determining that the second record format does not fully parse the dataset, and wherein displaying the results of the parsing of the dataset using the second record format via the user interface comprises displaying an alert that the second record format does not fully parse the dataset.

5. The method of claim 1, further comprising determining the first record format based at least in part on one or more heuristics to identify one or more characters as a potential delimiter.

6. The method of claim 5, wherein determining the first record format comprises identifying a character of the dataset that is not alphanumeric, a space, a quote, a period, a forward-slash or a hyphen, and generating a data field of the first record format that is delimited by the identified character.

7. The method of claim 1, wherein the first character is a non-printable character.

8. The method of claim 1, wherein the first record format includes only delimited data fields.

9. The method of claim 1, wherein the user input causes the at least one computing device to alter the selected user interface element's appearance in the user interface.

10. The method of claim 1, wherein displaying the results of said parsing of the dataset using the first record format via the user interface comprises displaying a list of records of the dataset and data field values of the records.

11. The method of claim 1, wherein the first record format includes a plurality of delimited data fields having a plurality of different delimiters.

12. A computer system comprising:
at least one processor;
at least one user interface device; and
at least one computer readable medium comprising processor-executable instructions that, when executed, cause the at least one processor to:
parse a dataset comprising a plurality of bytes using a first record format to determine a sequence of characters represented by the plurality of bytes and determining values of one or more data fields in accordance with the first record format;
display, via the at least one user interface device, at least some of the values of the one or more data fields of the first record format via the at least one user interface;
display, via the at least one user interface device, a plurality of the sequence of characters via the at least one user interface as a sequence of user interface elements, wherein each of the plurality of characters is presented as a separate user interface element;
receive, via the at least one user interface device, user input selecting a user interface element of the sequence of user interface elements, the selected user interface element being associated with a character of the sequence of characters; and
generate a second record format based on the received input, wherein the second record format is generated to include a data field delimited by the character associated with the selected user interface element.

13. The computer system of claim 12, wherein displaying the plurality of the sequence of characters comprises:
displaying a contiguous subset of the sequence of characters via the user interface as the sequence of user interface elements, wherein each character of the subset is presented in sequence as a separate user interface element.

14. The computer system of claim 12, wherein the processor-executable instructions further cause the at least one processor to:
parse the dataset using the second record format; and
display, via the at least one user interface device, results of said parsing of the dataset using the second record format via the user interface.

15. The computer system of claim 14, wherein the processor-executable instructions further cause the at least one processor to determine that the second record format does not fully parse the dataset, and wherein displaying the results of the parsing of the dataset using the second record format via the user interface comprises displaying an alert that the second record format does not fully parse the dataset.

16. The computer system of claim 12, wherein the processor-executable instructions further cause the at least one processor to determine the first record format based at least in part on one or more heuristics to identify one or more characters as a potential delimiter.

17. The computer system of claim 16, wherein determining the first record format comprises identifying a character of the dataset that is not alphanumeric, a space, a quote, a period, a forward-slash or a hyphen, and generating a data field of the first record format that is delimited by the identified character.

18. The computer system of claim 16, wherein determining the first record format comprises identifying a data record delimiter.

19. The computer system of claim 12, wherein the user input causes the at least one processor to alter the first user interface element's appearance in the user interface.

20. The computer system of claim 12, wherein displaying the results of said parsing of the dataset using the first record format via the at least one user interface device comprises displaying a list of records of the dataset and data field values of the records.

21. The computer system of claim 12, wherein the first record format includes a plurality of delimited data fields having a plurality of different delimiters.

22. A computer system comprising:
at least one processor;
means for parsing a dataset comprising a plurality of bytes using a first record format to determine a sequence of characters represented by the plurality of bytes and determining values of one or more data fields in accordance with the first record format;
means for displaying at least some of the values of the one or more data fields of the first record format via the at least one user interface;
means for displaying a portion of the sequence of characters via the at least one user interface as a sequence of user interface elements, wherein each character of the portion of the sequence of characters is presented in sequence as a separate user interface element;
means for receiving user input associated with a first user interface element of the sequence of user interface elements, the first user interface element associated with a first character of the sequence of characters; and
means for generating a second record format based on the received input, wherein the second record format is generated to include a data field delimited by the first character.

23. A method of determining a record format for a dataset, the dataset comprising a plurality of bytes, the method comprising, with at least one computing device:
iteratively receiving user input and generating record formats based upon the user input, said iterative process continuing until receiving user input indicating a most recently generated record format is to be output, said iterative process comprising repeating steps of:
parsing the dataset using an initial record format to determine a sequence of characters represented by the plurality of bytes and determining values of one or more data fields in accordance with the initial record format;
displaying at least some of the values of the one or more data fields in accordance with the initial record format via a user interface;
displaying a plurality of the sequence of characters via the user interface as a sequence of user interface elements, wherein each of the plurality of characters is presented as a separate user interface element;
receiving user input selecting a user interface element of the sequence of user interface elements, the selected user interface element being associated with a character of the sequence of characters; and
generating a subsequent record format based on the received input, wherein the subsequent record format is generated to include a data field delimited by the character associated with the selected user interface element.
